(19) United States
(12) Patent Application Publication
(10) Pub. No.: US 2019/0211422 A1
(43) Pub. Date: Jul. 11, 2019

(54) NOVEL SILICON-ENRICHED COMPOSITE MATERIAL, PRODUCTION METHOD THEREOF AND USE OF SAID MATERIAL AS AN ELECTRODE

(71) Applicants: Centre National D'Etudes Spatiales, Paris (75); SAFT, Bagnolet (FR); Centre National de la recherche scientifique, Paris (FR); Université de Montpellier, Montpellier (FR)

(72) Inventors: Christian JORDY, St. Louis De Montferrand (FR); Florent FISCHER, Bruges (FR); Fermin CUEVAS, Lardy (FR); Alix LADAM, Montpellier (FR); Laurent ALDON, Montpellier (FR); Pierre-Emmanuel LIPPENS, Saints Aunes (FR); Nicolas BIBENT, Montpellier (FR); Josette OLIVER-FOURCADE, Jacou (FR); Jean-Claude JUMAS, Jacou (FR)

(73) Assignees: Centre National D'Etudes Spatiales, Paris (FR); SAFT, Bagnolet (FR); Centre National de la recherche scientifique, Paris (FR); Université de Montpellier, Montpellier (FR)

(21) Appl. No.: 16/302,251

(22) PCT Filed: May 18, 2017
(86) PCT No.: PCT/EP2017/062046

§ 371 Date: Nov. 16, 2018

(30) Foreign Application Priority Data
May 19, 2016 (FR) 1654484

(51) Int. Cl. C22C 13/00; H01M 4/38; H01M 4/36; C22C 30/00

(52) U.S. Cl. CPC C22C 13/00; C22C 30/00; H01M 4/364; H01M 4/387

(57) ABSTRACT

The present invention relates to novel composite materials enriched with silicon dispersed in matrices comprising Ni, Ti and Si and/or Sn, optionally passivated, the method for producing said materials and to the use of same as electrodes. The invention further relates to the aforementioned matrices and the synthesis thereof.

The present invention relates to the field of energy storage and more particularly to that of composite intermetallic negative electrodes.

The new storage devices must contribute to the optimised management of energy enabling the integration of renewable energies into the energy mix. With regard to Li-ion accumulators, future systems must have much higher energy densities while also being safer with increasingly longer cycle and calendar lifetimes depending on applications (stationary, space, transport).

With regard to negative electrodes, intermetallic materials that are made from tin (Sn) or silicon (Si) are generally envisaged. They display high energy densities (600 to 4000 Ah/kg) but have significant aging related problems linked to several phenomena:
a mechanical degradation in the presence of lithium, linked to volume variations during cycling, increase in volume during the formation of LiₓSn or LiₓSi alloys, and contraction over the course of delithiation, resulting in fracturing of the electrode and a short life due to the loss of contacts (electronic percolation loss);
a chemical degradation that occurs at the electrode-electrolyte interface, which may be a simple decomposition or decomposition with reduction of salts or solvents of the electrolyte. It can be observed that there is the formation of a layer at the interface (SEI) that is of interest if it is fine and stable.

It is therefore essential both to control the volume expansion during the formation of LiₓSn or LiₓSi alloys and to absorb this expansion, as well as to protect the electrode from chemical etching.

In order to minimize the aforementioned degradation phenomena, several approaches have been developed (nanostructuring, dispersions, passivation layers).

The composite alloys of the Ni—Ti—Sn system have a broad cyclability range (in particular from 40 atomic % Sn) and good adhesion to the phosphate passivation layer generally applied in metallurgy. However their high atomic mass may be a handicap to achieving interesting mass capacities.

The composite alloys of the Ni—Ti—Si system are active only from 60 atomic % of Si. The existence of active and inactive Si-based particles is of interest for reducing the mechanical degradation and the low atomic mass largely compensates for the loss of active species. However, the material generally has poor adhesion to the passivation layer, and chemical degradation, although delayed, is inevitable after a certain number of cycles.

The solutions proposed still continue to not be fully satisfactory.

The inventors have thus identified that Ni—Ti—Si/Sn mixed composites having a high Si content thus make it possible to achieve greater capacity and good absorption of volume variations, and combined with more deformable Sn alloys, enable the adherence of the phosphate passivation layer. They therefore represent a solution to the problems encountered.

The present invention therefore provides novel electrode materials obtained by dispersing the active species (Sn, Si, Sn/Si) in a Ti—Ni—(Sn/Si) composite matrix, of multi-scale polycrystalline ceramic or glass-ceramic types, that present a large number of advantages (domains of distributed complex compositions with a medium-range order, possibility of combining different properties, ease of synthesis). In particular, these materials combine several properties: a high energy density with minimized volume expansion (Hume-Rothery intermetallics), an absorption of the residual volume expansion by dispersion of the active species in deformable inactive species systems, referred to as “shape memory”, as well as stable passivation thanks to Ni₂SnP type flexible solders.

The composite materials according to the invention therefore make it possible to: 1) minimize the volume expansion by means of a predictive model; 2) absorb the remaining volume variations by dispersing the active species in multi-scale polycrystalline composite systems or glass-ceramics in which certain compounds have “shape memory” and 3) possibly fixing these domains and protecting them with protective layers bonded by flexible welds by means of a synthetic passivation layer subsequently formed by interaction between the composite and the passivating system.

As used herein, the term “composite” is understood within the meaning of the present invention to refer to an assembly of at least two compounds that are immiscible (but having a high penetration capacity) whose properties complement each other. The novel material thus constituted, is heterogeneous, having properties that the compounds alone do not possess. More particularly, the said material may be formed of at least two defined compounds or elements, of different nature and/or dimensions, which behave as a single compound by virtue of an assembly that imposes a medium-range order. This arrangement then makes it possible to add the properties of the compounds without modifying them. The composite may be multi-scale polycrystalline, or glass-ceramic, vitreous.

According to a first object, the present invention relates to a composite material enriched with electrochemically active Si, having the formula (I-M):

(1−z)M+zSi (I-M)
Where M is a dispersion composite matrix based on Ti and Ni, and at least one element selected from Si and/or Sn;
z represents the molar ratio of silicon in the said material such that 0<z≤0.70.
According to one embodiment, the said dispersion composite matrix M is selected from among the following matrices:
a. Ni-, Ti-, and Sn-based dispersion composite matrices having the formula M1:

NiₓTi_{y}Sn_{1-(x+y)} (M1)
Where
0.20≤x≤0.30;
0.20≤y≤0.30;
b. Ni-, Ti-, Si-based composite dispersion matrices having the formula M2:

Ni_{x′}Ti_{y′}Si_{1-(x′+y′)} (M2)
Where
0.20≤x′≤0.30;
0.20≤y′≤0.30;
And
c. Mixed dispersion composite matrices M3 constituted of the matrices M1 and M2 defined in a. and b. here above, according to the formula:

M3=aM1+(1−a)M2
where 0<a<1,
where x, x′ and y, y′ respectively represent the respective molar ratios of the Ni and Ti species in the matrices M1 and M2, and a represents the molar ratio of the matrix M1 in the matrix M3.
The composite matrices according to the invention are constituted of intermetallic phases well distributed with Sn and/or Si species compositions generally comprised between 40 and 60 atomic %. The matrices M1 and M2 are respectively situated in the liquidus domains identified on the ternaries Ti—Ni—Sn and Ti—Ni—Si (FIGS. 1 and 2). In order to minimize volume expansion, the active compounds having electron concentrations situated in the same domain as those of LiₓSn or LiₓSi alloys, enabling their formation by means of displacement reaction with very small structural modifications. In order to absorb the volume expansion, the inactive NiTiMeᵤ (Me=Si, Sn; u≤1) compounds are stable alloys with shape memory capable of undergoing mechanical stresses by deformation without modification of volume. These composite matrices have great similarities while also being complementary. The Sn-based M1 type matrices are electrochemically active while the electrochemically inactive, Si-based M2-type matrices ensure a certain stability in cycling of the dispersed species. The matrix M3 combines these two properties in a mixed composite. The three matrices M1, M2 and M3 are enriched with silicon in order to optimise the capacity and are then defined as enriched composite materials.

In the case where the dispersion composite matrix is the matrix M1, the enriched composite material according to the invention then corresponds to the formula (I-M1):

(1−z)M1+zSi (I-M1)
Where z is as defined here above, and thus then corresponds to the formula (I-M1):

Ni_{x(1-z)}Ti_{y(1-z)}Sn_{(1-z)(1-x-y)}Si_{z} (I-M1)
Where
0.20≤x≤0.30;
0.20≤y≤0.30;
0<z≤0.70,
Where x, y and z are as defined here above.

In the case where the dispersion composite matrix is the matrix M2, the enriched composite material according to the invention corresponds to the formula (I-M2):

(1−z′)M2+z′Si (I-M2)
Where z′ is equal to z, as defined here above,
and thus then corresponds to the formula (I-M2):

Ni_{x′(1-z′)}Ti_{y′(1-z′)}Si_{1-(x′+y′)(1-z′)} (I-M2)
Where
0.20≤x′≤0.30;
0.20≤y′≤0.30;
0<z′≤0.70;
Where x′, y′ and z′ are as defined here above.

In the case where the dispersion composite matrix is the matrix M3, the composite material enriched according to the invention, corresponds to the formula (I-M3):

(1−z″)M3+z″Si (I-M3)
Where z″ is equal to z, as defined here above,
and thus then corresponds to the formula (I-M3):

Ni_{[x′+a(x-x′)](1-z″)}Ti_{[y′+a(y-y′)](1-z″)}Sn_{a(1-x-y)(1-z″)}Si_{(1-a)(1-x′-y′)(1-z″)+z″} (I-M3)
Where
0.20≤x≤0.30;
0.20≤x′≤0.30;
0<a<1
0.20≤y≤0.30;
0.20≤y′≤0.30;
0<z″≤0.70
Where x, x′, y, y′, a and z″ are as defined here above.

In order to minimize volume expansion a prediction model has been established on the basis of the HUME-ROTHERY studies, showing that metal systems of equivalent electron concentrations [e] are able adopt several compositions without deformation of the network. For tin-based materials these electron concentrations [e], involving only localized valence electrons, are directly related to Mössbauer isomeric shifts.

This predictive experimental model makes it possible to minimize the volume expansion by synthesizing the alloys that are placed in the domain that present electron concentrations [e] corresponding to the alloys rich in lithium LiₓSn (x˜3 to 4.2).

In order to absorb the still existing volume variations, the electrochemically active alloys have been combined with “shape memory” alloys, having the overall formula NiTiMeᵤ (Me=Si, Sn; u≤1). These alloys have an electron concentration that is sufficiently low (<1.5) so as not to be involved in the electrochemical process. These various active and inactive compounds are combined, the assembly thereof thus constituting the intermetallic composite material with specific properties (minimization and absorption of the volume expansion).

The composite material enriched according to the invention can be protected from chemical degradation in order to prevent the direct contact of the environment such as the electrolyte with the surface of the material.

Thus, the protection of the composite electrode vis-à-vis the electrolytic environment during the galvanostatic cycles of charging/discharging is ensured thanks to a coating of alkaline phosphates, the nickel reducing properties making it possible to ensure good adhesion between the protective layer and the composite while also ensuring a better contact with the current collector thanks to the formation of phosphides of Ni, Sn of type Ni₂SnP/Ni₁₀Sn₅P₃ used as flexible solder in semiconductors.

According to another object, the invention therefore also relates to the said passivated enriched composite material (I-M), comprising:
the enriched composite material having the formula (I-M) as defined here above and
a surface passivation layer.

The term “surface passivation layer” is used to refer to a thin, stable, electronically insulating and ionically conductive layer that can be applied to a material in order to prevent direct contact of the said material with its environment. Typically, the said passivation layer can be likened to a layer referred to as sold/electrolyte interface layer (SEI).

The passivation layer may be selected from among the layers usually used to protect the intermetallics. The enriched composite material that is possibly passivated according to the invention, is particularly suitable as an electrode material.

According to another object, the present invention therefore also relates to an electrode comprising:
a) an enriched composite material (I-M) comprising the composites I-M1, I-M2, and/or I-M3, according to the invention; and/or
b) an enriched composite material (I-M) passivated according to the invention, as defined here above.

Original matrices M have been developed so as to prepare the composite materials of the invention.
According to another object, the present invention therefore relates to a dispersion composite matrix having the formula (M1)

NiₓTi_{y}Sn_{1-(x+y)} (M1)
Where
0.20≤x≤0.30;
0.20≤y≤0.30;
Where x and y are as defined here above.

According to one embodiment, the dispersion composite matrix having the formula (M1) here above advantageously comprises the elements Ti, Ni, Sn in the following proportions (in atomic percentages):
20%≤Ni≤30%;
20%≤Ti≤30%;
40%≤Sn≤60%.

According to one embodiment, the dispersion composite matrix having the formula (M1) here above typically corresponds to the formula:

Ni₍₃₊ₙ₎ₜTi₆₍₁₋ₜ₎Sn₍₅₋ₜ₎

Where n is comprised between 0.3 and 0.7 and t is comprised between 0.50 and 0.75.

According to another object, the present invention also relates to the dispersion composite matrix having the formula (M3)

Ni_{x′+a(x-x′)}Ti_{y′+a(y-y′)}Sn_{a(1-x-y)}Si_{(1-a)(1-x′-y′)} (M3)

### Where

0.20≤x≤0.30;
0.20≤x′≤0.30;
0<a<1;
0.20≤y≤0.30;
0.20≤y′≤0.30;
   Where x, x′, y, y′ and a are as defined here above.

The present invention also relates to the preparation method for preparing the enriched composite material having the formula (I-M).

Typically, the synthesis method for synthesizing matrices is reactive grinding, carried out under conditions that are adjusted to the systems and to the composition domains. The grinding conditions generally depend on parameters such as rotational speed, ratio of powder mass/bead mass. Generally, these parameters are respectively 500 revolutions/minute for the speed of rotation, a ratio of about 1/28 for 15 mm diameter beads, it being understood that the grinding time comprised between 200 and 700 in particular, may be adapted according to the composition domain. Generally, the composites enriched with silicon may be synthesized by grinding in the liquidus domain. The term “reactive grinding” is understood herein to refer to the grinding of at least two compounds interacting with each other during the grinding, and resulting in a synthesized final composite material that is generally thermodynamically stable.

Two lanes may thus be used: i) by dispersion of the silicon in the preformed matrices M with compositions corresponding to the binary systems (1−z) M1−z Si and (1−z′) M2−z′ Si, (1−z″)M3−z″Si; or ii) by integration of the silicon from the compounds, binary for tin (Ni₃₊ₙSn₄ where n is comprised between 0.3 and 0.7, Ti₆Sn₅, Si); and from the elements (Ni, Ti, Si) for silicon with the same compositions as those of the lane i.

The step of grinding may generally be carried out for any mechanical method usually used, by application of procedures generally known to the person skilled in the art.

Typically, according to a first embodiment, the said method comprises the step of grinding of Si with the said dispersion composite matrix M, by means of z part of Si and (1−z) part of the said dispersion composite matrix M, where z is as defined here above.

According to another embodiment, the said method comprises the grinding of Si with the other elements constituting the composite matrix or with the alloys containing the said elements.

According to one embodiment, when the said enriched composite material (I-M2) does not contain Sn, then the method comprises grinding the elements Si, Ti, Ni in stoichiometric proportions.

According to another embodiment, when the enriched composite material (I-M) contains Sn, the said method comprises the grinding of Si with the alloys Ni₃₊ₙSn₄ and Ti₆Sn₅ where n is comprised between 0.3 and 0.7.

According to another object, the present invention relates to the preparation method for preparing the passivated enriched composite material (I-M) above. The said method generally comprises the placing in contact of the enriched composite material (I-M) with an aqueous solution of alkali metal phosphate, which may optionally be hydrated.

The placing in contact may be carried out by suspension or immersion of the material in the said aqueous solution or by application and/or spreading of the said solution over the said material.

Typically, the said mixture is produced in an acidic medium, at a temperature comprised between 20 and 80.

According to the invention, novel original methods have been developed for preparing the matrices M1, M2 and M3.

It involves the synthesizing of the stable composite intermetallic matrices M1, M2 and/or M3 thus enabling the dispersion of the active species Si.

The present invention therefore also relates to the preparation method for preparing the dispersion composite matrix having the formula (M1) comprising the grinding of the alloys Ni₆₊ₙSn₄ and Ti₆Sn₅ where n is comprised between 0.3 and 0.7.

Generally, the said method comprises the step of grinding of the alloys Ni₃₊ₙSn₄ and Ti₆Sn₅ in the molar ratio (Ni₃₊ₙSn₄)/(Ti₆Sn₅)=t/(1−t) where n is comprised between 0.3 and 0.7 and t is comprised between 0.50 and 0.75.

According to another object, the present invention also relates to the preparation method for preparing the dispersion composite matrix (M2) comprising the grinding of the elements Ni, T and Si in stoichiometric proportions.

According to another object, the present invention also relates to the preparation method for preparing the dispersion composite matrix (M3) by grinding the alloys Ni₃₊ₙSn₄ where n is comprised between 0.3 and 0.7 and Ti₆Sn₅, and the elements Ti, Ni and Si.

### FIGURES

FIG. 1 represents the ternary system Ti—Ni—Sn (isothermal section 800° C.) with the domain of composite materials M1 synthesized from the pseudo-binary t Ni₃₊ₙSn₄-(1−t) Ti₆Sn₅ with 0.3≤n≤0.7 and 0.50≤t≤0.75 corresponding to the ternary compositions TiₓNi_{y}Sn_{1-(x+y)} with 0.20≤x≤0.30 and 0.20≤y≤0.30, as well as the defined compounds and the shape memory alloys MF identified in the literature.

FIG. 2 represents the ternary system Ti—Ni—Si (isothermal section 1100° C.) with the domain of composite materials M2 synthesized from ternary compositions Ti_{x′}Ni_{y′}Si_{1-(x′+y′)}, with 0.20≤x′≤0.30 and 0.20≤y′≤0.30, as well as the defined compounds and the shape memory alloys MF identified in the literature.

FIG. 3 represents the electrochemical characteristics of the composite I-M2 (lane ii) enriched with silicon, optionally passivated.

FIG. 4 represents the electrochemical characteristics of the composite I-M3 (lane ii) enriched with silicon, optionally passivated.

FIG. 5 represents the electrochemical characteristics of the composite I-M1 (lane ii) enriched with silicon, passivated and heat-treated-passivated.

The present invention is illustrated here below by means of illustrative and non-limiting examples of embodiments.

### EXAMPLE 1: SYNTHESIS OF THE MATRICES

a) Matrices M1

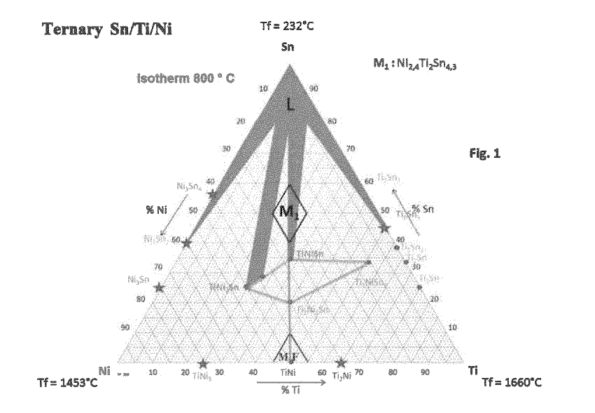

In order to avoid the premature melting of Sn (232° C.) during grinding, the tin-based matrices are synthesized from the pseudo-binary t Ni₃₊ₙSn₄-(1−t) Ti₆Sn₅ having the overall formula Ni_{3.6t}Ti₆₍₁₋ₜ₎Sn₅₋ₜ for different values of n comprised between 0.3 and 0.7, and t comprised between 0.50 and 0.75 (FIG. 1).

These different matrices are synthesized by reactive grinding under the same conditions (nature of jars, rate of filling, number of beads) with three grinding times (1 hr, 3 hrs, 10 hrs) in order to follow the evolution of the reactions. It is found that the 1 hr grinding corresponds to a phase of redistribution of the starting materials with probably a creation of interfaces observable by the widening of some X-ray diffraction lines. The grinding times of 3 hrs and 10 hrs show little structural differences and constitute reactive phases leading to a composite distributed differently according to the composition.

The matrix M1 of the global composition Ni_{0.277}Ti_{0.227}Sn_{0.496} corresponding to n=0.60 t=0.67 obtained after 3 hours of effective grinding is the most interesting. The X-ray diffraction characteristic of a highly divided material makes it possible to identify an inactive compound TiNiSn and domains that are more amorphized, modified active compounds of types Ni₃Sn₄ and Ti₆Sn₅. Mössbauer spectrometry confirms the presence of 23% of electrochemically inactive TiNiSn and 77% of active compounds.

This matrix M1 was electrochemically tested as a button cell from electrodes developed in the form of an ink constituted of the active material (70%)+carbon Y50A (18%)+CMC (12%) coated on a copper collector [Cycling conditions: C/10; potential window 1.5 V-0.01 V, Electrolyte free of additive]. It is electrochemically active with a reversible capacity of 393 Ah/kg. This reversible capacity is in agreement with the presence in this composite of 23% of inactive species of the type TiNiSn.

b) Matrix M2

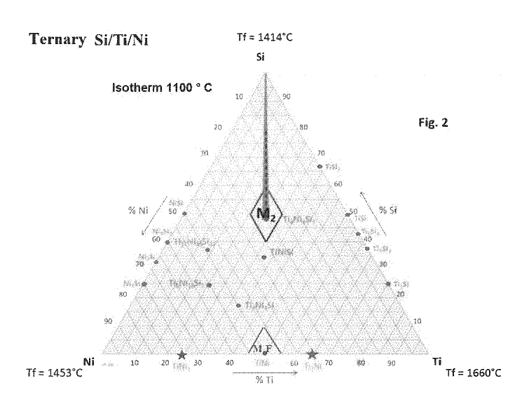

The melting point of silicon being high (1410° C.) the syntheses are carried out by grinding of the elements. The composition consisting of 26.7 at % of Ti, 26.7 at % of Ni, and 46.6 at % of Si having the overall formula Ni_{0.267}Ti_{0.267}Si_{0.466} (FIG. 2) was synthesized by grinding the elements in stoichiometric quantities with an effective grinding time of 12 hours.

The X ray diffraction diagram shows the presence of the phase Ti₄Ni₄Si₇. The broadening of the diffraction lines reflects the small size of the particles.

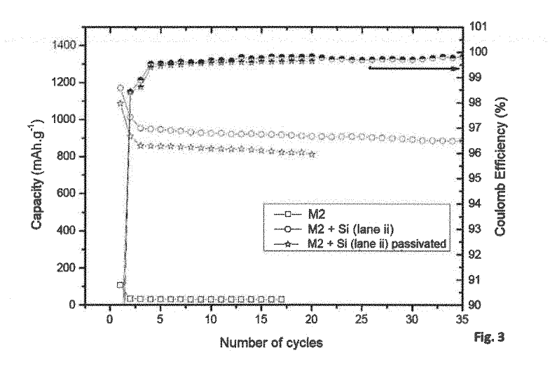

This matrix is electrochemicaly inactive (FIG. 3). By comparison with the analogous composition of the system Ti—Ni—Sn, the inactivity of this matrix accounts for the difference in nature between Sn and Si. The valence electrons of Silicon are engaged in bonds of greater covalency in tetrahedral coordination and the displacement reactions are not possible as long as the composition corresponds to continuous Si—Si—Si sequences.

c) Matrix M3

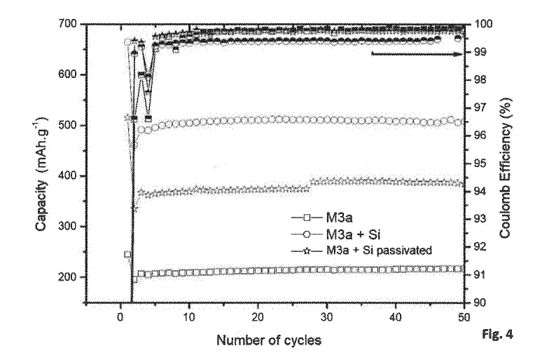

The matrix M3=a M1+(1−a) M2 with a=0.25 having the overall formula Ni_{0.27}Ti_{0.26}Sn_{0.12}Si_{0.35} was synthesized by 20 hrs of grinding of the mixture [0.25 M1+0.75 M2] M1 and M2 being obtained according to the methods described here above in 1a and 1b. The X-ray diffraction makes clearly evident the presence of crystallized β Sn and of the amorphized species of the ternary system Ti—Ni—Sn. Mössbauer spectrometry confirms the presence of β Sn, and shows the presence of a ternary compound that is electrochemically inactive and deformable and an active compound. In electrochemical analysis (FIG. 4), good cycle life and performance without curve shift and a capacity of ˜210 Ah/kg are observed. This capacity that is lower than that of M1 reflects the low number of active species. The Silicon was therefore introduced into the matrix to the detriment of tin. The loss n the 1^{st} cycle is high (40%) since a part of the lithium is inserted into the silicon compound of the matrix in an irreversible manner. On the other hand, the polarization is weak and the coulombic efficiency is high (99.7%).

### EXAMPLE 2: SYNTHESIS OF THE ENRICHED COMPOSITE MATERIALS

a) Composites I-M1 (M1 Enriched with Si) (Lane i)

The lane i consists in being placed on the binary system (1−z) M1−z Si. The composition N_{0.276}Ti_{0.227}Sn_{0.497}, situated in the liquidus zone (FIG. 1) was selected as matrix M1 for dispersing silicon by placing itself on the pseudo-binary (1−z) Ni_{0.277}Ti_{0.227}Sn_{0.496}+z Si with z=0.13. The composite I-M1 corresponds to the overall formula Ni_{0.241}Ti_{0.196}Sn_{0.432}Si_{0.13} (56 at % Sn+Si).

The synthesis was carried out by grinding the mixture of 0.87 M1+0.13 Si for a period of 3 hrs. The material obtained was characterized by X-ray diffraction, Mössbauer spectrometry and electrochemistry.

After grinding, the X-ray diffraction lines of the silicon are broadened and of low intensity.

The Mössbauer spectrum presents three sub-spectra, two major doublets corresponding to the active compounds (δ=2.09 mm/s, Δ=1.72 mm/s and δ=2.04 mm/s, Δ=0.76 mm/s) and one singlet (δ=1.52 mm/s) attributable to a stable ternary phase of type TiNiSn which is inactive in electrochemistry. The hyperfine parameters of the doublets substantially different from those observed for Ni_{0.276}Ti_{0.227}Sn_{0.497} would suggest that a part of the silicon has been integrated into the dispersion matrix M1.

The electrochemical tests show a reversible capacity ˜425 Ah/kg and a good cycle life performance over the 30 cycles performed. This reversible capacity that is lower than the theoretical capacity (670 Ah/kg) confirms that the silicon integrated into the matrix M1 is electrochemically inactive.

b) Composites I-M1 (M1 Enriched with Si) (Lane ii)

In order to verify the possibility of integration of the silicon into the matrix M1 the enriched composite I-M1 having the same overall formula as that described here above in 2a was synthesized from the binary phases of tin (Ni_{3.6}Sn₄ and Ti₆Sn₅) and from the silicon element according to lane ii. Thus the mixture 0.067 Ni_{3.6}Sn₄+0.033 Ti₆Sn₅+0.13 Si was ground for a period of 3 hrs.

In X-ray diffraction the diagram before grinding is characteristic of the three compounds (Ni_{3.6}Sn₄, Ti₆Sn₅, Si). After grinding, the amorphization of the material is quite significant, the lines of diffraction of the silicon have disappeared and the diffractogram is characteristic of a composite that is different from the one obtained by the lane i. Similarly, the Mössbauer spectrum is formed by a single doublet with hyperfine parameters (δ=2.04 mm/s and Δ=1.13 mms) that are different from those of the composite obtained by the lane i. These two techniques show that the silicon has been homogeneously integrated into the matrix.

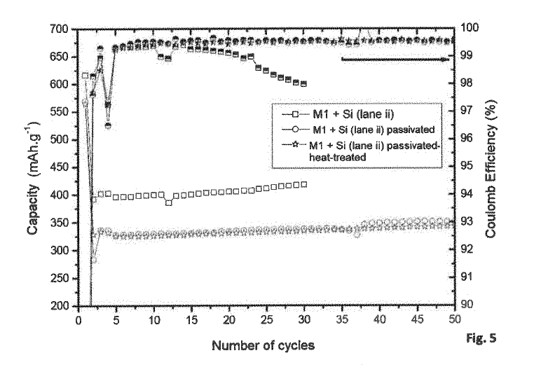

In electrochemical analysis (FIG. 5) a reversible capacity of ˜400 Ah/kg and a good degree of cycling stability over the first 30 cycles are observed. The reversible capacity is close to that observed for the composite obtained by lane i and much lower than the theoretical capacity, which confirms the total integration of the silicon within the matrix and the electrochemical inactivity thereof.

c) Composites I-M2 (M2 Enriched with Si) (Lane i)

The composites I-M2 enriched with silicon are obtained by being placed on the system (1-z′) M2+z′ Si. The composition of M2 selected for the enrichment, situated in the liquidus zone (FIG. 2), corresponds to the overall formula Ni_{0.276}Ti_{0.267}Si_{0.466}. With z′=0.55 the composite obtained corresponds to the overall formula Ni_{0.12}Ti_{0.12}Si_{0.76}. The synthesis was carried out by grinding the preformed matrix M2 and the silicon element (lane i) for an effective grinding time period of 12 hours. The resulting composite obtained was characterized by X-ray diffraction and electrochemistry. In X-ray diffraction, the majority presence of silicon and compounds of type Ti₅Si₃ or NiTi₄Si₄ and Ni₂Si₂ were identified. The electrochemical analysis provided for the observation of a reversible capacity ˜870 Ah/kg that is significantly lower than the theoretical capacity of 2097 Ah/kg calculated by taking into account the totality of the silicon present in the composite. This therefore confirms that the matrix M2 has been modified over the course of the synthesis and that only a part of the silicon added is electrochemically active. Thus, a part of the added silicon has been integrated into the composition domain of the inactive matrix Ni_{x′}Ti_{y′}Si_{(1-x′-y′)} with 0.4<1−x′−y′<0.6.

d) Composites I-M2 (M2 Enriched with Si) (Lane ii)

The same composition Ni_{0.12}Ti_{0.12}Si_{0.76} was synthesized by grinding the elements (lane ii) with an effective grinding time of 12 hrs.

The resulting composite obtained was characterized by X-ray diffraction and electrochemical analysis. In X-ray diffraction, the majority presence of silicon and compounds of type Ti₅Si₃ or NiTi₄Si₄ and Ni₂Si₂ was identified just as for the lane i. In electrochemical analysis (FIG. 3) a reversible capacity of ˜920 Ah/kg is observed which is dearly significantly lower than the theoretical capacity of 2097 Ah/kg calculated by taking into account the totality of the silicon present in the composite. However, notable findings include a better cycle life and performance and the absence of a shift at low potential observed for the composite obtained by the lane i.

e) Composite I-M3 (M3 Enriched with Si)

The composite I-M3 was synthesized by grinding for a period of 20 hours of the matrix M3 having the overall composition Ni_{0.27}Ti_{0.26}Sn_{0.12}Si_{0.35} obtained by the method described in Example 1.c and the silicon element with the proportions 0.57 Ni_{0.27}Ti_{0.26}Sn_{0.12}Si_{0.35}+0.43 Si leading to the overall formula Ni_{0.15}Ti_{0.15}Sn_{0.07}Si_{0.63}.

For the Composite I-M3 enriched with silicon the X diffraction makes clearly evident the presence of β Sn, Si and of the amorphized species of the system Ti—Ni—Sn—Si. In Mössbauer spectrometry the presence of β Sn is confirmed, with the presence of an electrochemically active species. The enrichment with silicon significantly improves the reversible capacity (511 Ah/kg, FIG. 4) as compared to M3, however with a weakened coulombic efficiency.

### EXAMPLE 3: PROTECTION OF THE COMPOSITE ELECTRODE

Protection of the composite electrode vis-à-vis the electrolytic environment during the galvanostatic charge/discharge cycles is ensured by applying a coating of alkaline phosphates, the nickel reducing properties making it possible to ensure good adhesion between the protective layer and the composite while also ensuring a better contact with the current collector thanks to the formation of ternary phosphides of type Ni₂SnP used as flexible solder in semiconductors.

Ni₂SnP known for its deformable properties is formed in situ by reaction between the phosphate passivation layer and the composite thanks to the catalytic properties of the nickel released during the grinding of Ni₃₊ₙSn₄ with n comprised between 0.30 and 0, 70. The composites are passivated with a solution of acidified sodium phosphate at pH=2. This solution is prepared from sodium phosphate monohydrate (NaH₂PO₄, H₂O) at a concentration of 90 g/L (between 40 and 140 g/l). After dissolution of the phosphate in water, the solution is then acidified with orthophosphoric acid (H₃PO₄) until obtaining a pH equal to 2 (between pH=1.5 and pH=2.5). In order to passivate the composites, the latter are mixed with the phosphate solution and placed in a bath thermostated at 40° C. (between 20 and 80° C.) for a period of 4 hours, with magnetic stirring or bubbling (flow of nitrogen through a sinter). After reaction, the passivated composite is recovered by filtration on Büchner devices, and then dried under vacuum at 80° C. for a period of 12 hours. The product thus obtained is then used as electrode material.

a) Protection of the Composite I-M1 (Lane ii)

The composite I-M1 (Lane ii) was prepared by grinding for a period of 3 hours of the mixture 0.067 Ni_{3.6}Sn₄+0.033 Ti₆Sn₅+0.13 Si corresponding to the overall formula Ni_{0.241}T_{0.197}Sn_{0.432}Si_{0.13}. The passivation thereof was carried out according to the method previously described above and one of the passivated samples was heat-treated at 250° C. under argon. These three materials were electrodeposited in the form of inks of active material composition (70%)+carbon Y50A (18%)+CMC (12%) coated on a copper collector and tested in electrochemical analysis [Cycling conditions: C/10; potential window 1.5 V-0.01 V, Electrolyte free of additive] (Table 1).

TABLE 1
Electrochemical data for the composites M1 (lane ii), I-M1, I-M1 passivated, and
I-M1 passivated-heat-treated.

| | Capacity | Cycling | Theoretical | | Coulombic |
|---|---|---|---|---|---|
| | at 1^{st} Cycle | Capacity | Capacity | Polarization | Efficiency |
| Composite | (Ah/kg) | (Ah/kg) | (Ah/kg) | (V) | (%) |
| M1 | 532 | 393 | 542 | 0.23 | 98.90 |
| I-M1 | 620 | 400 | 672 | 0.38 | 99.20 |
| I-M1 Passivated | 598 | 330 | 672 | 0.47 | 99.50 |
| I-M1 Passivated | 564 | 327 | 672 | 0.25 | 99.50 |
| Heat-treated | | | | | |

These results are illustrated in FIG. 5.

Protecting the composite I-M1 does not modify the nature of the material. The surface layer results in a slight increase in loss in the 1^{st} cycle and an increase in polarization. The decrease in cycling capacity results from the involvement of tin in the passivation layer, resulting in a slight improvement in coulombic efficiency. The effect of the heat treatment is manifested by a noticeable decrease in the polarization as a consequence of greater adhesion with preserved coulombic efficiency.

b) Protection of the Composite I-M2 (Lane ii)

Composite I-M2 (Lane ii) was prepared by grinding for a period of 12 hrs of the mixture of 12% Ti, 12% Ni and 76% Si corresponding to the overall formula Ni_{0.12}T_{0.12}Si_{0.76}. The passivation thereof was carried out according to the method described here above. These two materials were electrodeposited in the form of inks of active material composition (70%)+carbon Y50A (18%)+CMC (12%) coated on a copper collector and tested in electrochemical analysis [Cycling conditions: C/10; potential window 1.5 V-0.01 V, Electrolyte free of additive] (Table 2).

TABLE 2
Electrochemical data for the composite M2 (lane ii)
enriched with silicon and passivated.

| | Capacity | | | | |
|---|---|---|---|---|---|
| | at | Cycling | Theoretical | Polar- | Coulombic |
| | 1^{st} Cycle | Capacity | Capacity | ization | Efficiency |
| Composite | (Ah/kg) | (Ah/kg) | (Ah/kg) | (V) | (%) |
| M2 | 108 | 30 | — | — | — |
| I-M2 | 1168 | 921 | 2047 | 0.27 | 99.70 |
| I-M2 | 1089 | 839 | 2097 | 0.28 | 99.50 |
| Passivated | | | | | |

These results are illustrated in FIG. 3.

The enrichment with silicon of the matrix M2 (electrochemically inactive) leads to remarkable electrochemical performance measures (Table 2). Protecting the silicon enriched composite M2 does not improve these performance measures. These results show that silicon is not strongly involved in the protective layer which proves to be inoperative. By comparison with the results obtained for the composite M1, it is apparent that tin thus plays a role in the effectiveness of passivation.

c) Protection of the Composite I-M3 [0.25 M1 (Lane ii)+0.75 M2 (Lane ii) Enriched with Si]

The composite I-M3 was synthesized by grinding for a period of 20 hrs of the mixture 0.57 M 3+0.43 Si leading to the overall formula Ni_{0.153}Ti_{0.146}Sn_{0.071}Si_{0.630}.

TABLE 3
Electrochemical data for the composites M3, I-M3 and I-M3 passivated.

| | Capacity | | | | |
|---|---|---|---|---|---|
| | at | Cycling | Theoretical | Polar- | Coulombic |
| | 1^{st} Cycle | Capacity | Capacity | ization | Efficiency |
| Composite | (Ah/kg) | (Ah/kg) | (Ah/kg) | (V) | (%) |
| M3 | 351 | 211 | 841 | 0.30 | 99.70 |
| I-M3 | 836 | 511 | 1560 | 0.30 | 98.10 |
| I-M3 | 674 | 370 | 1560 | 0.44 | 99.70 |
| passivated | | | | | |

These results are illustrated in FIG. 4.

The passivation of the silicon-enriched composite M3a consumes a portion of the tin as is shown by the X-ray diffraction pattern. As a result, the cycling capacity decreases (Table 3). Tin is therefore indeed involved in the passivation layer and coulombic efficiency is significantly improved (99.7%).

### CONCLUSIONS

In the composite M1 (NiₓTi_{y}Sn_{1-(x+y)} with 0.20≤x≤0.30 and 0.20≤y≤0.30) tin is active in cycling. The enrichment with silicon is possible but it is more or less integrated into the composition domain of the matrix M1 and becomes inactive. The tin contained in the matrix M1 remains active but is not sufficiently protected from the causes of aging. The enrichment with silicon improves the mechanical strength of the composite electrode due to the inactivity of the silicon-containing compound. The passivation consumes approximately 10% of the tin and thus the tin directly participates in the adhesion of the passivation layer of the composite. Whereas the reversible capacity is slightly decreased the coulombic efficiency is significantly improved. For this type of composite the capacity remains insufficient.

In the composite M2 (Ni_{x′}Ti_{y}Si_{1-(x′+y′)} with 0.20≤x′≤0.30 and 0.20≤y′≤0.30) the formation is observed of a defined nanostructured compound Ni₄Ti₄Si₇ which is already identified in the literature. This composite is virtually inert electrochemically. The enrichment with Si corresponds to a global composition of 76 atomic % silicon substantially above the 60% defined as the limit of the inactive composite M2. The electrochemical performance measures are remarkable (870 Ah/kg cycling) with an interesting level of coulombic efficiency (99.7%). The passivation does not improve electrochemical performance. Tin therefore plays a role in the effectiveness of passivation.

In the mixed composite M3a (0.25 M1+0.75 M2) the capacity is relatively low due to the composition Sn+Si<60% with as a consequence the inactivity of silicon. However the polarization is very weak and the coulombic efficiency is high (99.7%). The enrichment with silicon corresponding to the compositions Sn+Si˜70% improves the cycling capacity. Passivation consumes a part of the tin which significantly improves coulombic efficiency.

1. A composite material enriched with electrochemically active Si, having the formula (I-M):
(1−z)M+zSi (I-M)
Where M is a dispersion composite matrix based on Ti and Ni, and at least one element selected from Si and/or Sn;
And 0<z≤0.70.

2. An enriched composite material (I-M) according to claim 1, such that the dispersion composite matrix M is selected from among the following matrices:
a. Ni-, Ti-, and Sn-based dispersion composite matrices having the formula M1:
NiₓTi_{y}Sn_{1-(x+y)} (M1)
Where
0.20≤x≤0.30;
0.20≤y≤0.30;
b. Ni-, Ti-, Si-based composite dispersion matrices having the formula M2:
Ni_{x′}Ti_{y′}Si_{1-(x′+y′)} (M2)
Where
0.20≤x≤′50.30;
0.20≤y′≤0.30; and
c. Mixed dispersion composite matrices M3 constituted of the matrices M1 and M2 defined in a. and b. here above, according to the formula:
M3=aM1+(1−a)M2
where
0<a<1.

3. An enriched composite material (I-M) according to claim 1, such that the dispersion composite matrix is the matrix M1,
corresponding to the formula (I-M1):
(1−z)M1+zSi (I-M1)
Where z is as defined in claim 1.

4. An enriched composite material according to claim 1, having the formula (I-M1):
Ni_{x(1-z)}Ti_{y(1-z)}Sn_{(1-z)(1-x-y)}Si_{z} (I-M1)
Where
0.20≤x≤0.30;
0.20≤y≤0.30;
0≤z≤0.70.

5. An enriched composite material according to claim 1, such that the dispersion composite matrix is the matrix M2,
Corresponding to the formula (I-M2):
(1−z′)M2+z′Si (I-M2)
Where z′ is equal to z, as defined in claim 1.

6. An enriched composite material according to claim 1, having the formula (I-M2):
Ni_{x′(1-z′)}Ti_{y′(1-z′)}Si_{1-(x′+y′)(1-z′)} (I-M2)
Where
0.20≤x′≤0.30;
0.20≤y′≤0.30;
0≤z′≤0.70.

7. An enriched composite material according to claim 1, such that the dispersion composite matrix is the matrix M3,
Corresponding to the formula (I-M3):
(1−z″)M3+z″Si (I-M3)
Where z″ is equal to z, as defined in claim 1.

8. An enriched composite material according to claim 1, having the formula (I-M3):
Ni_{[x′+a(x-x′)](1-z″)}Ti_{[y′+a(y-y′)](1-z″)}Sn_{a(1-x-y)(1-z″)}Si_{(1-a)(1-x′-y′)(1-z″)+z″} (I-M3)
Where
0.20≤x≤0.30;
0.20≤x′≤0.30;
0<a<1
0.20≤y≤0.30;
0.20≤y′≤0.30;
0<z″≤0.70.

9. A passivated enriched composite material (I-M) comprising the enriched composite material having the formula (I-M) according to claim 1 and a surface passivation layer.

10. A passivated enriched composite material (I-M) according to claim 9, wherein the passivation layer is phosphate-based.

11. An electrode comprising:
a. an enriched composite material (I-M) or mixtures thereof according to any one of claims 1 to 8 and/or
b. a passivated enriched composite material (l-M) or mixtures thereof according to claim 9.

12. A preparation method for preparing the enriched composite material having the formula (I-M) according to claim 1 comprising the step of grinding of Si:
i. Either with the said dispersion composite matrix M,
By means of z part of Si and (1−z) part of the said dispersion composite matrix M,
Where z is as defined in claim 1;
ii. Or with the other elements constituting the composite matrix or with the alloys containing the said elements.

13. A method according to claim 12 such that when the said enriched composite material (I-M) does not contain Sn, Si is coground with Si, Ti, Ni in stoichiometric proportions.

14. A method according to claim 12, such that when the enriched composite material (I-M) contains Sn, the said method comprises the grinding of Si with the alloys Ni₃₊ₙSn₄ and Ti₆Sn₅ where n is comprised between 0.3 and 0.7.

15. A dispersion composite matrix having the formula (M1)
NiₓTi_{y}Sn_{1-(x+y)} (M1)
Where
0.20≤x≤0.30
0.20≤y≤0.30

16. A dispersion composite matrix having the formula (M1) according to claim 15, such that it corresponds to the formula Ni₍₃₊ₙ₎ₜTi₆₍₁₋ₜ₎Sn₍₅₋ₜ₎
Where n is comprised between 0.3 and 0.7 and t is comprised between 0.50 and 0.75

17. A dispersion composite matrix having the formula (M3)
Ni_{x′+a(x-x′)}Ti_{y′+a(y-y′)}Sn_{a(1-x-y)}Si_{(1-a)(1-x′-y′)} (M3)
Where
0.20≤x≤0.30;
0.20≤x′≤0.30;
0<a<1;
0.20≤y≤0.30;
0.20≤y′≤0.30.

18. A preparation method for preparing the dispersion composite matrix having the formula (M1) according to claim 15 comprising the grinding of the alloys Ni₃₊ₙSn₄ and Ti₆Sn₅ where n is comprised between 0.3 and 0.7

19. A method according to claim 18 comprising the step of grinding of the alloys Ni₃₊ₙSn₄ and Ti₆Sn₅ in the molar ratio (Ni₃₊ₙSn₄)/(Ti₆Sn₅)=t/(1−t) where n is comprised between 0.3 and 0.7 and t is comprised between 0.50 and 0.75.

20. A preparation method for preparing the dispersion composite matrix (M2) according to claim 2, comprising the grinding of the elements Ni, Ti and Si in stoichiometric proportions.

21. A preparation method for preparing the dispersion composite matrix (M3) according to claim 2 by grinding the alloys Ni₃₊ₙSn₄ where n is comprised between 0.3 and 0.7 and Ti₆Sn₅, and the elements Ti, Ni and Si.

22. A preparation method for preparing the passivated enriched composite material (I-M) according to claim 9, comprising the placing in contact of the enriched composite material (I-M) with an aqueous solution of alkali metal phosphate, which may optionally be hydrated.
